(19) United States
(12) Patent Application Publication
(10) Pub. No.: US 2012/0055851 A1
(43) Pub. Date: Mar. 8, 2012

(54) METHOD AND APPARATUS FOR PRODUCING LIQUID HYDROCARBON FUELS FROM COAL

(76) Inventor: Ronald Kyle, Akron, OH (US)

(21) Appl. No.: 13/185,708

(22) Filed: Jul. 19, 2011

Related U.S. Application Data
(60) Provisional application No. 61/380,954, filed on Sep. 8, 2010.
(60) Provisional application No. 61/416,889, filed on Nov. 24, 2010.
(60) Provisional application No. 61/419,653, filed on Dec. 3, 2010.
(60) Provisional application No. 61/423,768, filed on Dec. 16, 2010.

(51) Int. Cl. C10G 1/00; B01J 19/12

(52) U.S. Cl. 208/402; 422/186

(57) ABSTRACT

A method of converting coal into a liquid hydrocarbon fuel utilizes a high pressure, high temperature reactor which operates upon a blend of micronized coal, a catalyst, and steam. Microwave power is directed into the reactor. The catalyst, preferably magnetite, will act as a heating media for the microwave power and the temperature of the reactor will rise to a level to efficiently convert the coal and steam into hydrogen and carbon monoxide.

### CROSS-REFERENCE TO RELATED APPLICATIONS

This application claims priority of U.S. Provisional Patent Application 61/380,954 filed Sep. 8, 2010, U.S. Provisional Patent Application 61/416,889 filed Nov. 24, 2010, U.S. Provisional Patent Application 61/419,653 filed Dec. 3, 2010, and U.S. Provisional Patent Application 61/423,768 filed Dec. 16, 2010, the contents of which are incorporated herein by reference.

### FIELD OF THE INVENTION

This invention relates to a method of producing hydrocarbon fuels, primarily from coal, and more particularly to a method for performing the process involving a reactor powered by microwave energy.

### BACKGROUND OF THE INVENTION

The desirability of creating liquid hydrocarbon fuels from coal is well recognized, and a number of processes for performing the conversion have been used commercially and others have been proposed. However, all the previous methods and apparatus for practicing the methods have been relatively complicated and inefficient. There still exists a need for a simple, one step, continuous process that will produce liquid petroleum products from a blend of coal and water in the presence of a catalyst and a single reactor, thus substantially reducing capital and operating costs of the operation.

### SUMMARY OF THE INVENTION

The proposed process will be used to produce a mixture of petroleum-like products that are equivalent to liquid fuels and other hydrocarbons that are produced from petroleum. This stream of petroleum-like products (the “petroleum products”) will be sold or transferred to a typical refining operation that will separate and further process them into useful products such as gasoline, diesel fuel, and other products. This unique process is a simple, one-step, continuous process that will produce these petroleum products from a blend of coal and water in the presence of a catalyst in a single reactor, thus reducing capital and operating costs by about 30%.

Currently converting coal into petroleum products requires complicated and expensive facilities and processes.

A blend of coal, a catalyst (typically magnetite), and steam are fed to the reactor as shown in Schematic A. Oxygen also may be added in the event the process requires more oxygen than is generated in the reactor. The coal and magnetite will be micronized so that the particle size of these materials is typically about 10 microns. However, the optimum particle size will be determined by the application and may range up to 70 microns.

Any reasonable type of coal can be used: anthracite, bituminous, lignite, coal fines, etc. from any state or territory of the U.S. and any imported coal. The preferred method for micronizing the coal is outlined in my patent application Ser. No. 12/837,091. However, any reasonable micronizing method may be used.

The U.S. National Mining Association reported that in 2008 the U.S. recoverable reserves were estimated to be more than 261 billion tons, about 200 years of demand, and the U.S. national reserve base is greater than 487 billion tons, about 370 years of demand.

The World Coal Institute estimates that there are over 847 billion tons of proven coal reserves worldwide, enough to last about 119 years at current rates of production. Based on DOE energy content estimates for bituminous coal and domestic crude oil, these 847 billion tons of coal are equivalent to about 3.0 trillion barrels of crude oil. Coal reserves are available in almost every country worldwide, with recoverable reserves in about 70 countries. The biggest reserves are in the U.S., Russia, China, and India.

The catalyst magnetite is a naturally occurring ferrimagnetic mineral with the chemical formula Fe₃O₄, and is one of several iron oxides and a member of the spinel group. The common chemical name is ferrous-ferric oxide. Other suitable materials may be used separately or in a reasonable mixture with magnetite and/or other catalysts. Magnetite is available in the sizes required for this reaction. However, the same method described above for micronizing coal also can be used for magnetite. The magnetite will act both as a heating medium and chemical catalyst, as it speeds the rates of both reactions and after being used, it can be recovered and returned to the process.

The reactor liner may be made from quartz, ceramics, glass, or any other suitable material that is transparent to microwave power and can withstand temperatures up to about 1800° Celsius and pressures up to 500 psig. The quartz reactor can be reinforced with carbon fibers or other microwave transparent materials as necessary to withstand these pressures.

These high temperatures will be present in the bottom portion, the lower 30% to 50% of the reactor, and will convert the coal and water to carbon monoxide and hydrogen. To maintain the required temperature for this process in this lower portion of the reactor, microwave power will be supplied to the products in the reactor through a “window” in the reactor wall. One or more microwave units and respective “windows” may be used to focus the microwave energy on the coal, steam, oxygen, and catalyst mixture in a manner that will maintain reasonable process control. The magnetite will act as a heating medium for the microwave power and the temperature of the reactor mixture will quickly rise to that required to efficiently convert the coal and steam into hydrogen and carbon monoxide.

As soon as the hydrogen and carbon monoxide are produced in the presence of the magnetite or other catalyst(s) they will immediately react to form a mixture, or stream, of petroleum products such methane, ethane, propane, butane, alcohols, naphtha, gasoline, kerosene, gas oil, distillate, lube oils, motor oil, lubricants, grease, heavy fuel oils, aromatics, coke, asphalt, tar, waxes, etc. As these petroleum products are produced they add heat to the reactor and will rise to the top 50% or 70% of the reactor. A cooling water jacket(s) will be provided to cool this top portion of the reactor and help maintain a reasonable temperature profile in the reactor.

Carbon dioxide also is produced in the reactor and as soon as it is generated, it will immediately combine with carbon from the coal to also form carbon monoxide. This carbon monoxide will be immediately consumed for the formation of petroleum products. This proposed process will produce only about one-half of the carbon dioxide that would be generated by the conventional methods that are currently used to produce petroleum products from coal.

Another advantage of the proposed process is that the reactor coproduct carbon dioxide can be further converted to carbon monoxide by the injection of additional carbon dioxide into the reactor in accordance with the Le Chatelier principle. By this principle, approximately 50% of the sum of the carbon dioxide in the reactor plus the carbon dioxide injected into the reactor will be converted to carbon monoxide.

Consequently, using this proposed process in accordance with the Le Chatelier principle will effectively convert most or all of the coproduct carbon dioxide in the reactor to carbon monoxide, which will immediately react with hydrogen to form petroleum products. The excess carbon dioxide from this reaction can be re-injected into the reactor to convert the current coproduction carbon dioxide to carbon monoxide and petroleum products. Today's conventional processes have no reasonable method for using the excess coproduct carbon dioxide, so it typically must be removed and disposed of reasonably.

In addition to the carbon dioxide produced by the process, carbon dioxide produced from other fossil-fueled processes can be added to the feed stream of the reactor and used to produce petroleum products in this same manner. For example, the exhausts, or flue gases, which typically are composed of carbon dioxide, water vapor, and nitrogen produced from electric power plants or other industrial processes powered with coal, petroleum, natural gas, or other fossil fuels, can be used as feedstock for this process. Water, oxygen, and other materials can be added as required to get the desired petroleum products.

In addition to the reactions noted above for carbon dioxide, third party simulations confirm that when carbon dioxide and hydrogen are added to the reactor that these materials will react to form carbon monoxide and water.

The carbon dioxide may be separated from these exhaust gases generated by the combustion of fossil fuels and fed to the reactor as described above, or it may be more reasonable to feed the total exhaust stream to the reactor.

For example, the flue gases from coal-fired electric power plants can be fed directly to the reactor. In this case, the carbon dioxide from the flue gases will selectively react with hydrogen to form carbon monoxide and water. Third party simulations confirm that it is reasonable to expect this reaction. The nitrogen in the flue gas will be released from the process into the atmosphere. The utilities may use the process referenced above for micronizing coal. This process will also clean the coal of sulfur, metals such as mercury, ash, etc. Cleaning the coal prior to combustion, combined with the usual post-combustion methods used to clean the regulated components from the flue gases, will insure that the flue gases released from the reactor, after the carbon dioxide has been removed and used as feedstock to produce petroleum products, will meet current emission regulations.

Another option is to add a separate reactor to convert the excess carbon dioxide from this process and carbon dioxide produced from other fossil-fueled processes to petroleum products. The carbon dioxide and water blended in a certain ratio, and magnetite or other suitable catalyst(s), will be fed to the separate reactor. As noted above, the catalyst will act both as a heating medium and chemical catalyst, as it quickens the rates of the chemical reactions and after being used, it can be recovered and returned to the process. As noted, above the heat added to the process will be provided by a microwave system or other suitable electromagnetic-radiation system. The carbon from the carbon dioxide and hydrogen from the water in the presence of the catalyst and heat will combine to form petroleum products as described above.

Cooling water circulated around the outside of the reactor will carry away any excess heat generated in the reactor and maintain the proper reactor temperature profile. If appropriate, cooling water also may be circulated inside the reactor in tubes or other suitable apparatus. In summary, the temperature profile will be maintained by controlling the microwave power and frequency, the volume of the catalyst, the steam injection volume, the oxygen injection volume, and the reactor cooling water rate. The cooling water as it absorbs heat from the reactor will become steam, which will be injected into the reactor as steam is required. The balance of the steam from the cooling system will be cooled and reused to cool the reactor or replaced by fresh water.

The magnetite and/or other catalysts and any other solid materials can be removed from the petroleum products by common separators such as centrifugal separators, magnetic separators, cyclonic separators, or any other reasonable method. The recovered magnetite or catalysts can be cleaned and returned to the reactor. Any ash can be removed and sold or disposed of reasonably.

The remaining petroleum products will be sold or transferred to a typical refining operation where they will be separated into the respective fuel and other products as desired.

### BRIEF DESCRIPTION OF THE DRAWINGS

Other objectives, advantages, and applications of the present invention will be made apparent by the following detailed description of two preferred embodiments of the invention. The description makes reference to the accompanying drawings in which:

FIG. 1 is a schematic drawing of a first embodiment of the invention; and

FIG. 2 is a schematic diagram of a second embodiment of the invention in which carbon dioxide produced from other fossil fuel processes can be added to the feed stream of the reactor thereby enhancing the production of petroleum products and avoiding release of the carbon dioxide effluent from the fossil fuel processes into the atmosphere.

### DETAILED DESCRIPTION OF PREFERRED EMBODIMENTS OF THE INVENTION

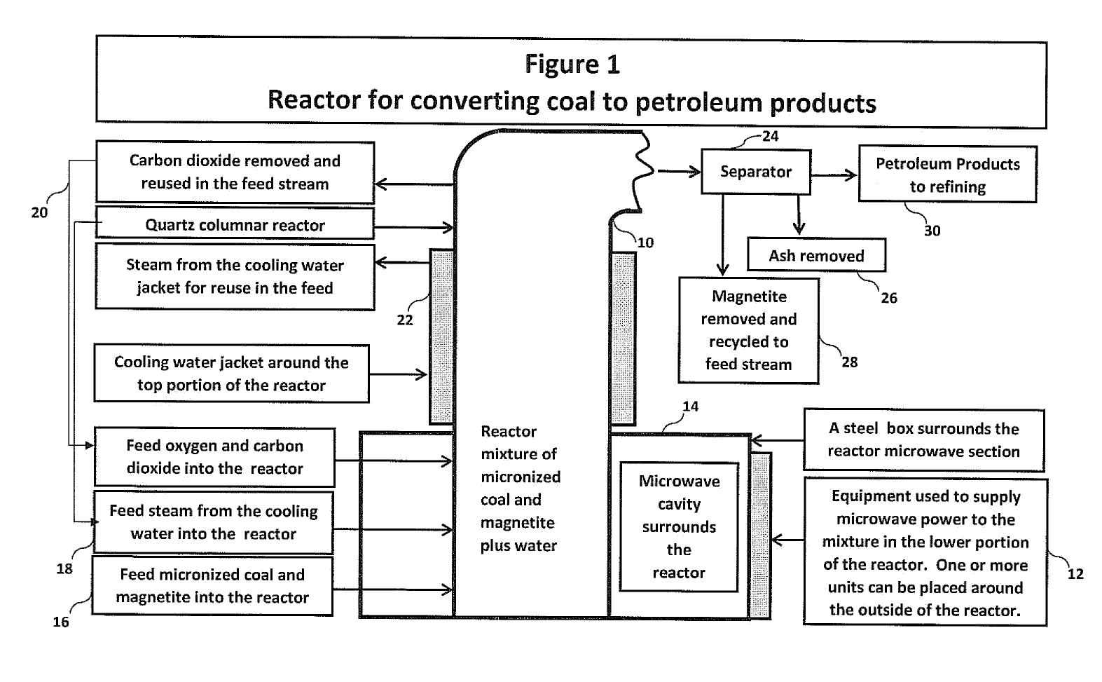

Referring to the schematic diagram of FIG. 1, the reactor proper comprises a vertically oriented furnace. The reactor 10 may have an internal lining of quartz or other suitable material that is transparent to microwave power and can withstand temperatures in the range of 1800° C. and pressures in the range of 500 psig. The reactor 10 may be reinforced with carbon fibers or any suitable microwave transparent material. The upper portion of the reactor 10 could have an outer casing of a material which is not transparent to microwaves. One or more microwave generators 12 will be supported in a cavity 14 which surrounds the base of the reactor 10.

The base of the reactor 10 is fed with micronized coal and micronized magnetite at 16. The coal is preferably micronized into the range of 10 microns, preferably by the process disclosed in my copending patent application Ser. No. 12/837,091, the entire disclosure of which is incorporated herein by reference. The magnetite may be micronized to a similar particle size by the same process or other well known processes. Steam is also fed into the base of the reactor at 18, preferably from a cooling water jacket surrounding the upper section of the reactor 10 as will be subsequently described. The steam and the coal will react to produce hydrogen and carbon monoxide. Carbon dioxide produced by the reaction may be removed from the top of the reactor and fed into the base of the reactor at 20, possibly along with oxygen from an external source which may be added as necessary to maintain the reaction at a reasonable level.

As the hydrocarbon reaction products rise in the reactor, the upper end of the reactor is surrounded by a cooling water jacket 22.

The petroleum products produced in the reaction will pass out of the reactor into a separator 24 which divides the output product by removing ash at 26, removing magnetite which is removed and recycled to the feed stream 16 at 28. The remaining petroleum products are removed at 34 refining.

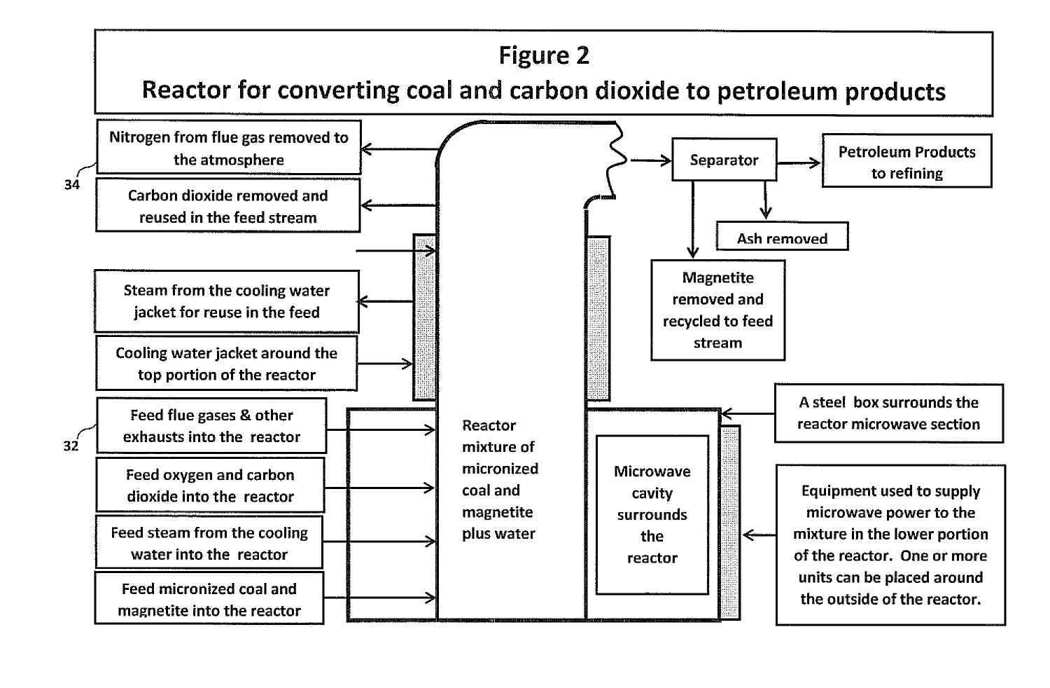

Since carbon dioxide combines with carbon from the coal, it is possible to add carbon dioxide from other fossil fuel processes, such as the exhaust or flue gases from electric power plants and other industrial processes, thereby productively utilizing the carbon dioxide and eliminating its emission into the atmosphere. FIG. 2 is a schematic diagram of a reactor, very similar to the reactor of FIG. 1, which differs only in that the effluents of other fossil fuel processes are fed into the base of the reactor at item 32. Additionally, nitrogen from the flue gas may be removed to the atmosphere at item 34. Thus, in addition to converting coal into petroleum products, the system of FIG. 2 may be used to minimize the emission of carbon dioxide into the atmosphere and the resultant enhancement of the greenhouse effect.

The resulting processes of the present invention will produce a stream of clean petroleum products, cleansed of impurities such as sulfur, mercury, other metals, and ash.

The process variables may be changed to produce the preferred balance of petroleum products in the output stream. For example, during certain seasons there is a greater need for fuel oil/distillate and at other times there is a greater need for gasoline/naphtha. This selectivity can be accomplished by balancing the microwave power and frequency, the volume and type of the catalyst system, the steam injection volume, the oxygen injection volume, the reactor cooling water rate, and other parameters.

This single stage, continuous, simple process has a much better thermal efficiency than that of the currently used conventional processes. The proposed process requires a lower energy input than prior art processes. The present process is started by using microwave power to add heat to the reactor. As the process continues, it generates heat energy within the reactor and the microwave needs only to supply the incremental heat required to maintain a reasonable temperature profile over the reactor. The temperature profile, as has been noted, may range from about 1800° C. at the bottom of the reactor to about 500° C. at the top of the reactor.

Having thus described my invention, I claim:

1. (canceled)

2. The process of claim 13, wherein the carbon dioxide produced in the reactor combines with the coal and/or hydrogen in the steam to form carbon monoxide which is consumed in the formation of the petroleum products.

3. The process of claim 15, wherein additional carbon dioxide is injected into the base of the reactor and whereby a substantial portion of the sum of carbon dioxide produced in the reaction plus the carbon dioxide injected into the reactor is converted to carbon monoxide which is consumed in the formation of the petroleum products.

4. The process of claim 13, wherein the reactor comprises a vertical column having a base and a top, the base having windows of a material transparent to microwaves and said microwaves are injected through the windows to react with the catalyst and initiate the process.

5. The process of claim 4, wherein the reaction products emerge from the top of the reactor and are passed to a separator which removes ash, unspent catalyst and carbon dioxide for recycling to the reactor feed, and outputs petroleum products for refining.

6. The process of claim 4, further comprising a cooling water jacket surrounding the top portion of the reactor wherein the heat of the reactor converts a portion of the water into steam which is fed into the base of the reactor.

7. The process of claim 4, wherein carbon dioxide is removed from the top of the reactor and fed into the base of the reactor where it combines with carbon from the coal to form carbon monoxide.

8. The process of claim 13, wherein oxygen is fed into the base of the reactor to feed the reaction.

9. The process of claim 4, wherein carbon dioxide emissions from separate fossil fuel powered processes, such emissions including carbon dioxide, are fed into the reactor base for entry into the reaction.

10. The process of claim 4, wherein at least the base of the reactor is formed with quartz.

11. The method of converting coal and carbon dioxide into petroleum products comprising:
subjecting micronized coal and particulate magnetite to microwaves and steam into a reactor;
introducing microwave energy into the reactor; and
separating the output products by removing the ash and magnetite to produce petroleum products for refining.

12. The method of claim 11, further adding carbon dioxide emissions from fossil fuel processes into the reactor.

13. A process for converting coal to petroleum products, comprising:
introducing coal having a particle size of less than about 100 microns into a reactor;
introducing steam into the reactor;
introducing particles of a catalytic material, absorbent of microwave energy into the reactor; and
irradiating the catalytic material in the reactor with microwave energy to heat the catalyst and cause gasification of coal and steam to produce hydrogen and carbon monoxide which react to produce petroleum products; whereby
the catalyst will accelerate an exothermic reaction between the carbon monoxide and hydrogen to produce the petroleum products.

14. The process of claim 13, wherein the catalyst comprises magnetite.
